(19) United States
(12) Patent Application Publication
(10) Pub. No.: US 2016/0178075 A1
(43) Pub. Date: Jun. 23, 2016

(54) STRENGTHENED VALVE

(71) Applicant: E-LEAD ELECTRONIC CO., LTD., Changhua (TW)

(72) Inventor: Stephen CHEN, CHANGHUA (TW)

(21) Appl. No.: 14/577,989

(22) Filed: Dec. 19, 2014

(51) Int. Cl. F16K 15/20; B60C 29/06

(52) U.S. Cl. CPC F16K 15/205; B60C 29/066

(57) ABSTRACT

The invention relates to a strengthened valve, which includes: a tube body, an external thread is set on an outer edge of the tube body; an elastic slip-piece, which is a hollow structure, is previously glued with the tube body as an air-tight condition; a sleeve, which is a hollow structure, an internal threaded hole is set on an inner edge of its top, the sleeve is slipped on the elastic slip-piece when the strengthened valve is put on a rim, the internal threaded hole of the sleeve is fastened on the external thread of the tube body, a bottom of the sleeve is against outer side of the rim; by composition of above structure, tolerance of the strengthened valve for centrifugal force effect may be strengthened that tire deflated condition may not happened during high speed driving, to thereby improve road safety.

### BACKGROUND OF THE INVENTION

a) Field of the Invention

The invention relates to a strengthened valve and, more particularly, a strengthened valve with tolerance strengthened for centrifugal force effect, and position of the strengthened valve may be adjusted according to the thickness of rims that customized production for different rims are not needed, it is ensured that tire deflated condition may not happened during high speed driving by structure of the strengthen valve, to thereby improve road safety.

b) Description of Related Art

Since driving safety is relevant to normal car tire pressure, tire pressure display (or device) may be listed as one of important car equipments by various car manufacturers, tire pressure detection devices are usually set on tire nozzles, original copper products may be replaced by aluminum products for weight reduction. In temperate, boreal regions where may snow, salt may be used to sprinkle on roads for snowmelting, but aluminum products may be corroded by salt so that nozzles may be rapid aging easily and then gas may leak.

As shown in FIG. 1, in order to solve this problem, a so-called rubber air nozzle is developed by the industry. The structure of this kind of air nozzle is that a copper tube body 11 is used inside, a rubber cover body 12 is covered on outside edge of the tube body 11, a barb groove 13 set on the rubber cover body 12 is used to fasten on the rim, to ensure that inner edge of the air nozzle may be attached to inner part of the rim, a thread segment may be set inside the air nozzle cover 14 of the air nozzle, the thread segment is correspondingly fastened on the thread segment 111 of the tube body 11, with pushing force of inner air pressure, so that it may be closer without leaking.

However, under high speed driving, since the air nozzle may be forced toward the direction of an inner part of a tire by pulling force effect produced by centrifugal force, fastening force of the barb groove 13 and pulling force of inner air pressure may be balanced, so that the inner edge of the air nozzle cannot be tightly attached to the inner side of the rim, and air leakage condition may be caused; for this reason, rubber tire is not suitable for high speed driving, the nozzle leakage condition may easily be happened when driving on unlimited highway in German especially.

In order to solve this drawbacks, the industry develop and improve actively, relative patents, such as TW I344539, TW M485835, TW 372071, TW M312444, TW I388752, TW Publication No. 201343429, TW I325833, TW M302483, TW M268205, TW M400955, TW M487214, may be referred.

Refer to technology of above patents, some technical manners related to car air nozzle and tire pressure detection have been disclosed already. However, it cannot be satisfied with how to strengthen the tire pressure leak-proof effect for improving driving safety, there are still some technological bottlenecks needed to overcome in improving air nozzle structure.

### SUMMARY OF THE INVENTION

In view of this, the inventor finally completes the strengthened valve of the present invention after numerous improvements, namely, the object of the present invention is to provide a strengthened valve with tolerance strengthened for centrifugal force effect, and position of the strengthened valve may be adjusted according to the thickness of rims that customized production for different rims are not needed, it is ensured that tire deflated condition may not happened during high speed driving by structure of the strengthen valve, to thereby improve road safety.

To achieve the above object according to the invention, a strengthened valve of the present invention includes:

a tube body, an external thread is set on its outer edge;

an elastic slip-piece, which is a hollow structure, is previously glued with the tube body as an air-tight condition;

a sleeve, which is a hollow structure, an internal threaded hole is set on an inner edge of its top, the sleeve is slipped on the elastic slip-piece when the strengthened valve is put on a rim, the internal threaded hole of the sleeve is fastened on the external thread of the tube body, a bottom of the sleeve is against outer side of the rim.

The strengthened valve of the present invention further includes a hard pad, which is slipped on a bottom of the elastic slip-piece, to thereby strengthen the elastic slip-piece to improve its fastness.

The above sleeve is plastic material.

The strengthened valve of the present invention further includes a tire pressure detection device, which is slipped on the tube body, used to provide tire pressure detection, a housing of the tire pressure detection device is against the bottom of the elastic slip-piece, to thereby strengthen the elastic slip-piece to improve its fastness.

The strengthened valve further includes a screw, which is fastened on the bottom of the tube body.

The strengthened valve further includes a valve cover, which is fastened on the top of the tube body.

The above elastic slip-piece, a ledge is set on outer edge of the elastic slip-piece, and lower of the ledge is against outer side of the rim.

The above elastic slip-piece, wherein a slot is set on the outer edge of the elastic slip-piece, the slot is slipped on a rim.

The above elastic slip-piece, wherein a block part is set on its outer edge, upper of the block part is against inner side of the rim.

The above elastic slip-piece is plastic material.

The above tube body is metal material.

### BRIEF DESCRIPTION OF THE DRAWINGS

FIG. 1 is a three-dimensional exploded schematic diagram of a conventional valve;

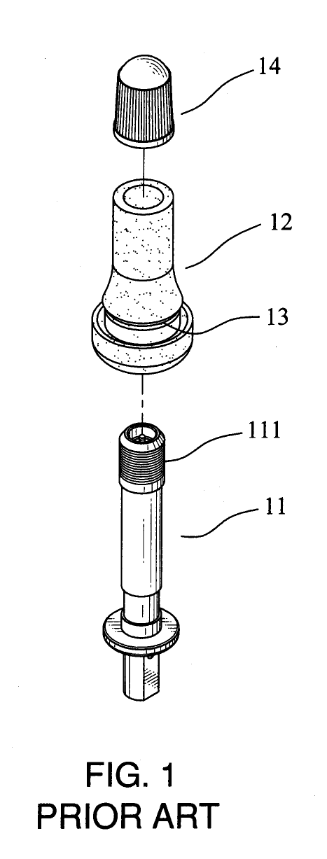

FIG. 2 is a three-dimensional exploded schematic diagram of the first embodiment of the present invention;

FIG. 3 is a three-dimensional schematic diagram of the first embodiment of the present invention;

FIG. 4 is a three-dimensional exploded diagram of the second embodiment of the present invention; and

FIG. 5 is a three-dimensional schematic diagram of the second embodiment of the present invention.

### DETAILED DESCRIPTION OF THE INVENTION

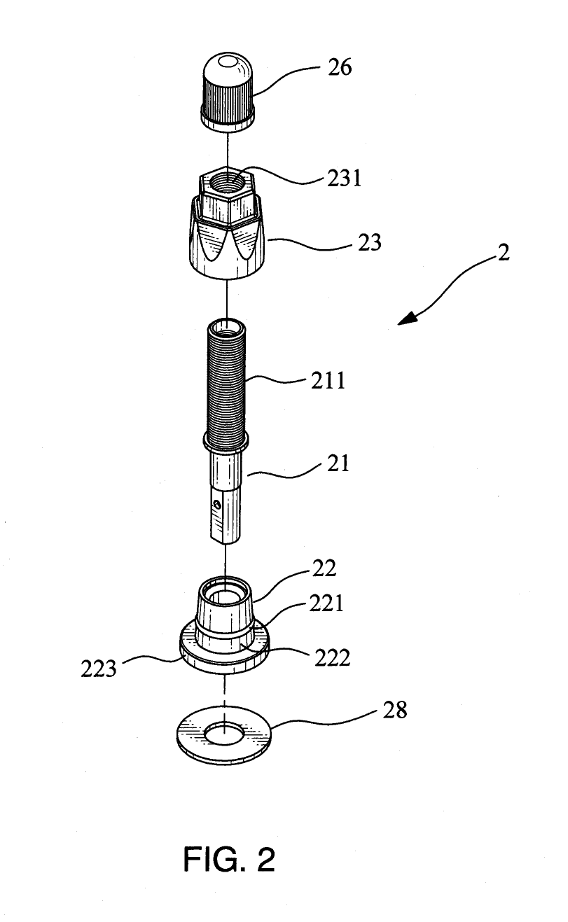

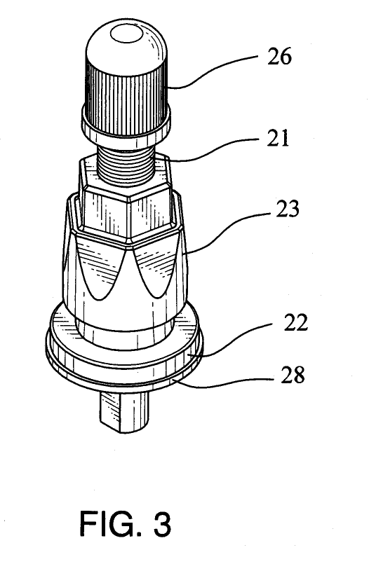

Please refer to FIG. 2 and FIG. 3, which relative to a first embodiment of the strengthened valve 2 of the present invention, which includes:

a tube body 21, which is a hollow structure, an external thread 211 is set on its outer edge, the tube body 21 is metal material;

an elastic slip-piece 22, which is a hollow structure, is previously glued with the tube body 21 as an air-tight condition;

a sleeve 23, which is a hollow structure, the sleeve 23 is plastic material, an internal threaded hole 231 is set on an inner edge of its top, the sleeve 23 is slipped on the elastic slip-piece 22 when the strengthened valve 2 is put on the rim, the internal threaded hole 231 of the sleeve 23 is fastened on the external thread 211 of the tube body 21, a bottom of the sleeve 23 is against outer side of the rim, position of the strengthened valve 23 may be adjusted according to the thickness of the rim that customized production for different rims are not needed.

The strengthened valve 2 further includes a hard pad 28, which is slipped on a bottom of the elastic slip-piece 22, to thereby strengthen the elastic slip-piece 22 to improve its fastness, the hard pad 28 is metal or plastic material.

The elastic slip-piece 22, a ledge 221, a block part 222 and a slot 223 are set on its outer edge, lower of the ledge 221 is against outer side of the rim, the slot is slipped on a rim, upper of the block part 222 is against inner side of the rim.

By composition of the above structure, tolerance of the strengthened valve of the present invention for centrifugal force effect may be strengthened, torque force caused by centrifugal force may directly force on the elastic slip-piece 22 and indirectly perform on the rim, the sleeve 23 is strengthened so that inner and outer parts of the elastic slip-piece 22 are clamped by hard objects, to thereby increase its fastness, to reduce the condition that a nozzle may become skew because of centrifugal force and gas may leak, to achieve the purpose that no gas leakage condition during high speed driving.

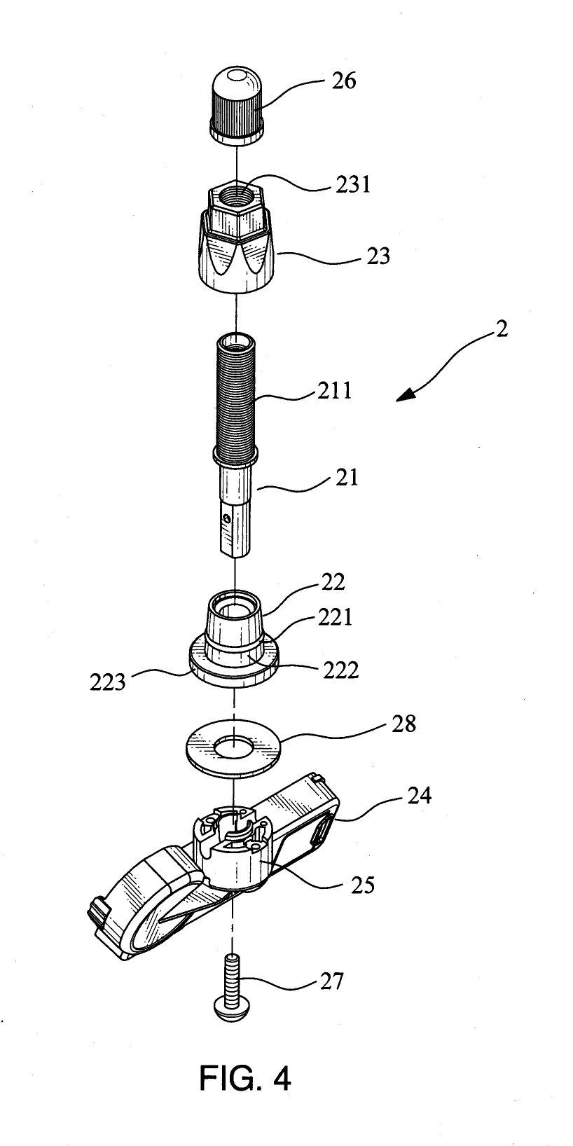

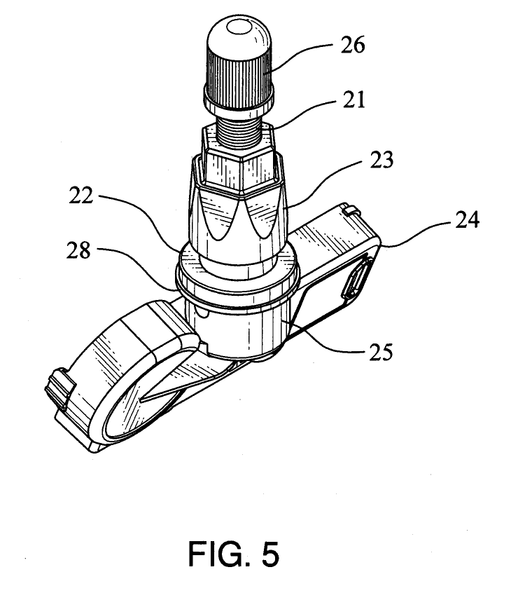

Please refer to FIG. 4, FIG. 5, a second embodiment of the strengthened valve 2 of the present invention includes:

a tube body 21, which is a hollow structure, an external thread 211 is set on its outer edge, the tube body 21 is metal material;

an elastic slip-piece 22, which is a hollow structure, is previously glued with the tube body 21 as an air-tight condition;

a sleeve 23, which is a hollow structure, the sleeve 23 is plastic material, an internal threaded hole 231 is set on an inner edge of its top, the sleeve 23 is slipped on the elastic slip-piece 22 when the strengthened valve 2 of the tire pressure detection device is put on the rim, the internal threaded hole 231 of the sleeve 23 is fastened on the external thread 211 of the tube body 21, a bottom of the sleeve 23 is against outer side of the rim, position of the strengthened valve 23 may be adjusted according to the thickness of the rim that customized production for different rims are not needed;

a tire pressure detection device 24, which is slipped on the tube body 21, is used to provide tire pressure detection, a housing 25 of the tire pressure detection device 24 is against the bottom of the elastic slip-piece 22, to thereby strengthen the elastic slip-piece to improve its fastness.

The strengthened valve 2 of the present invention further includes a valve cover 26, which is fastened on the top of the tube body 21.

The strengthened valve 2 further includes a screw 27, which is fastened on the bottom of the tube body 21.

The strengthened valve 2 of the present invention further includes a hard pad 28, which is slipped on a bottom of the elastic slip-piece 22, to thereby strengthen the elastic slip-piece 22 to improve its fastness, the hard pad 28 is metal or plastic material.

The elastic slip-piece 22, a ledge 221, a block part 222 and a slot 223 are set on its outer edge, lower of the ledge 221 is against outer side of the rim, the slot 223 is slipped on a rim, upper of the block part 222 is against inner side of the rim.

By composition of the above structure, tolerance of the strengthened valve of the present invention for centrifugal force effect may be strengthened, especially under the structure that the housing 25 of the tire pressure detection device 24 is against the block part 224, firstly it could be prevented that the elastic slip-piece 22 may deform with the passing of time, also torque force caused by centrifugal force may directly force on the elastic slip-piece 22 and indirectly perform on the rim, the sleeve 23 is strengthened so that inner and outer parts of the elastic slip-piece 22 are clamped by hard objects, to thereby increase its fastness, to reduce the condition that a nozzle may become skew because of centrifugal force and gas may leak, to achieve the purpose that no gas leakage condition during high speed driving.

What is claimed is:

1. A strengthened valve, which includes:
a tube body, an external thread is set on its outer edge;
an elastic slip-piece, which is a hollow structure, is previously glued with the tube body as an air-tight condition;
a sleeve, which is a hollow structure, an internal threaded hole is set on an inner edge of its top, the sleeve is slipped on the elastic slip-piece when the strengthened valve is put on a rim, the internal threaded hole of the sleeve is fastened on the external thread of the tube body, a bottom of the sleeve is against outer side of the rim.

2. The strengthened valve as claimed in claim 1, further includes a hard pad, which is slipped on a bottom of the elastic slip-piece, to thereby strengthen the elastic slip-piece to improve its fastness.

3. The strengthened valve as claimed in claim 1, wherein the sleeve is plastic material.

4. The strengthened valve as claimed in claim 1, further includes a screw, which is fastened on the bottom of the tube body.

5. The strengthened valve as claimed in claim 1, further includes a tire pressure detection device, which is slipped on the tube body, used to provide tire pressure detection, a housing of the tire pressure detection device is against the bottom of the elastic slip-piece, to thereby strengthen the elastic slip-piece to improve its fastness.

6. The strengthened valve as claimed in claim 1, further includes a valve cover, which is fastened on the top of the tube body.

7. The strengthened valve as claimed in claim 1, wherein a ledge is set on outer edge of the elastic slip-piece, lower part of the ledge is against outer side of the rim.

8. The strengthened valve as claimed in claim 1, wherein a slot is set on the outer edge of the elastic slip-piece, the slot is slipped on a rim.

9. The strengthened valve as claimed in claim 1, wherein a block part is set on the outer edge of the elastic slip-piece, upper part of the ledge is against an inner side of the rim.

10. The strengthened valve as claimed in claim 1, wherein the elastic slip-piece is plastic material.

11. The strengthened valve as claimed in claim 1, wherein the tube body is metal material.
